(19) United States
(12) Patent Application Publication
(10) Pub. No.: US 2018/0373345 A1
(43) Pub. Date: Dec. 27, 2018

(54) Keyboard Layout For Balanced Typing

(71) Applicant: Rehaan Irfan Furniturewala, Encino, CA (US)

(72) Inventor: Rehaan Irfan Furniturewala, Encino, CA (US)

(73) Assignee: Rehaan Irfan Furniturewala, Encino, CA (US)

(21) Appl. No.: 16/104,887

(22) Filed: Aug. 18, 2018

Related U.S. Application Data
(60) Provisional application No. 62/547,113, filed on Aug. 18, 2017.

(51) Int. Cl. G06F 3/02

(52) U.S. Cl. CPC G06F 3/0219; G06F 3/0216

(57) ABSTRACT

The present invention discloses a unique ergonomic keyboard layout i.e. the “REHAAN BSQ” keyboard which can be utilized as an interface for entry of characters and data into electronic devices like computers, smartphones etc. which are operated with hands. The keyboard layout comprises of English alphabets, Roman numerals, and other symbols and characters. The keyboard layout is basically an alphabetically-arranged layout to facilitate use and access to the keys by users who have not yet developed proficiency with the standard QWERTY-style keyboards and could benefit from a design that utilizes both hands more effectively, therefore reducing the risk of stress-related injury. The alphabetically arranged layout has three rows wherein the upper-row comprises of “BGPMW.CUFY,V”, the home-row comprises of “SNITLHEAORD”, and the lower-row comprises of “Q:;X{[?/}]K′″JZ|\”. This unique keyboard layout provides a better usage of the left and the right hand while also balancing the usage of all fingers.

### FIELD OF THE INVENTION

The present invention relates to a keyboard used to input data into an electronic device and more specifically to an improved ergonomic layout such that the keyboard balances the usage of both hands and fingers evenly.

### BACKGROUND OF THE INVENTION

Keyboards are the most standard apparatus for inputting data into electronic devices, such as computers, smart watches and tablets. As a result, they have increased in popularity/application concurrently with the computer. Computers are employed for various applications by every age group. Adults use them to carry out their jobs in the workplace. Students utilize them in schools as a means to develop essays and learn new concepts. They are also used casually for entertainment purposes, such as watching movies and playing video-games. In addition, they are useful as a database for knowledge. Computers are also accessible in other means, such as smartphones, which are handheld devices that are carried on a person.

A conventional keyboard layout used in computers, smartphones, tablets and other electronic devices has a number of keys which allows the user to provide data input and control other operations of the electronic device. The keys which are provided in the conventional keyboards include both alphabets and numerical character input keys and other specific keys like Ctrl, Alt and other special characters like +, −, *, /, @, #, $, % and so on.

On a conventional keyboard, the alphanumeric character input keys are arranged in the traditional QWERTY manner. That is to say the keys are arranged in four rows. A first top row contains the numeric keys 1, 2, 3, 4, 5, 6, 7, 8, 9, 0, while three lower rows contain the alphabetic characters. The first row has the letters Q, W, E, R, T, Y, U, I, O, P, the second row has the letters A, S, D, F, G, H, J, K, L and the third row has the letters Caps, Z, X, C, V, B, N, M and backspace. Another row is present below which contains space and settings key.

The conventional keyboard layout is the QWERTY layout, which was designed in the nineteenth century for the type-writer. In this manual typewriter, the individual letters were formed at the ends of arms which moved when a key was struck so as to strike the paper through an inked ribbon. The keys on the layout were spread out such that the most frequent keys were separated from each other, resulting in a general inefficiency. The inventor purposefully designed the keyboard layout be inefficient, in order that the keys would not jam on the typewriter, because the distribution of the keys would prevent the user from typing too fast.

In the span of a hundred years, the layout has fundamentally remained the same. Although the solution of making the keyboard inefficient so that they would not jam was beneficial in the nineteenth century, jamming doesn't pose a slightest of issue with modern computers in the twenty-first century, especially due to the fact that keyboards function electronically instead of purely mechanically. In fact, making the keyboard less efficient is harmful, in that it forces the user to exercise their fingers more to produce the same output. As a result, the ineffective nature of the QWERTY keyboard poses a risk to the users, because it is more likely to cause stress in the hands and fingers and typing injuries such as Carpal Tunnel Syndrome can result.

The QWERTY layout possesses some other general drawbacks. For instance, despite most users being right-handed, the QWERTY keyboard layout requires the user to use their left-hands more. Despite the fact that keyboard users place their fingers along the middle row in the resting position, the QWERTY layout has most usage in the upper row, obligating the user to extend their finger further.

As millions and potentially billions of people type as is the norm of the future, it is essential to provide a more user friendly and logical ordering of the keys, based on the frequency of use, in order to reduce the likelihood of typing injuries.

### OBJECTIVES OF THE INVENTION

The primary objective of the present invention is to provide an ergonomic keyboard layout that provides better balanced usage of both hands and each individual finger.

Another objective of the present invention is to provide an ergonomic keyboard layout called “Rehaan BSQ” keyboard, which replaces the 34 keys of the “QWERTY” keyboard that forms the main body of the keyboard.

### SUMMARY OF THE INVENTION

The “REHAAN BSQ” keyboard presents a more ergonomic keyboard layout. The inventive concepts described herein generally are concerned with the layout of keyboards utilized as an interface for the entry of characters and data into electronic devices like computers, smartphones, and tablets etc. which are operated with hands. The keyboard layout comprises of English alphabets, Roman numerals, and other symbols and characters. The keyboard layout is basically an alphabetically-arranged layout to facilitate use and access to the keys by users who have not yet developed proficiency with the standard QWERTY-style keyboards and could benefit from a design that utilizes both hands more effectively, therefore reducing the risk of stress-related injury.

The unique keyboard layout which is described in the “REHAAN BSQ” keyboard comprises of the alphanumeric characters in the following order. There are three rows in the keyboard layout wherein the first or the upper-row comprises of “BGPMW.CUFY, V”, the second or the home-row comprises of “SNITLHEAORD”, and the third or the lower-row comprises of “Q:;X{[?/}]K′″JZ|\”.

This unique keyboard layout is more efficient since it provides a better usage of the left and the right hand while also balancing the usage of all fingers. Since most people are right-handed, the keys are laid out in a manner to increase usage of the right hand. Similarly, the keys are laid out in a manner that there is maximum usage of home-row which reduces the stress on wrist tendons. The home-row is the middle row of a keyboard and therefore is the easiest to access for a user, because the default finger positions rest on the home-row. By placing the alphabets and special characters in such a pattern, one can type with lower risk of stress related injuries.

### BRIEF DESCRIPTION OF THE DRAWINGS

FIG. 1 illustrates the different fingers of the right and left hand as referenced in this document.

FIG. 2 represents the unique layout of the “REHAAN BSQ” keyboard.

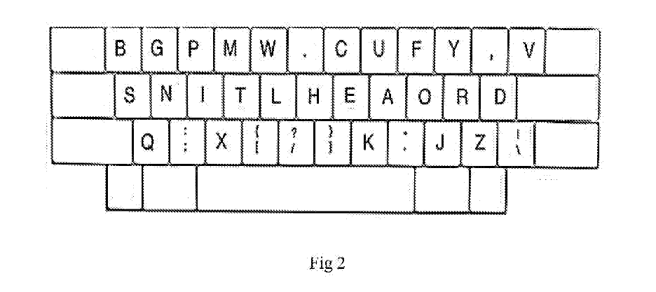

FIG. 3 shows the keys of “Rehaan BSQ” superimposed on a traditional QWERTY keyboard.

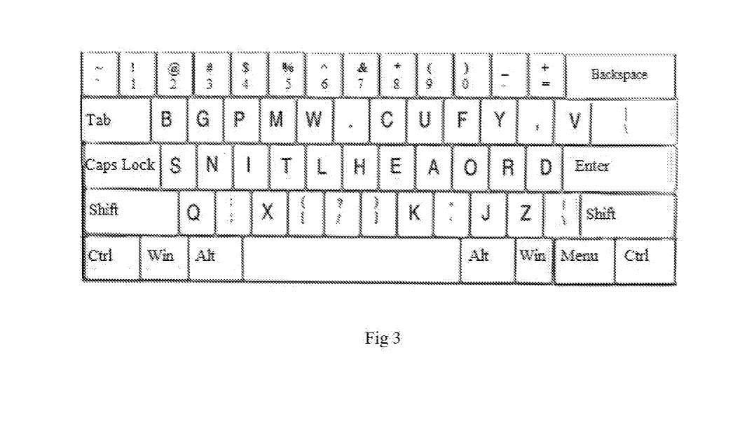

### DETAILED DESCRIPTION OF THE DRAWINGS

The “REHAAN BSQ” keyboard describes an ergonomic keyboard layout utilized as an interface for the entry of characters and data into electronic devices like computers, smartphones, tablets etc. The keyboard layout comprises of English alphabets, Roman numerals, and other symbols and characters which are arranged in a specified manner to facilitate the user to access all the keys more conveniently. This can also be used by the users who have been newly introduced to the keyboard layout and have not developed proficiency.

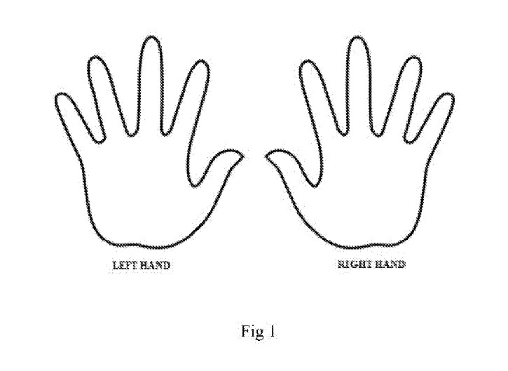

FIG. 1 describes the three rows in the keyboard layout used in the “REHAAN BSQ” keyboard. The unique keyboard layout comprises of the characters in the following order. There are three rows in the keyboard layout wherein the first or the upper-row comprises of “BGPMW.CUFY,V”, the second or the home-row comprises of “SNITLHEAORD”, and the third or the bottom-row comprises of “Q:;X{[?/}]K′″JZ|\”.

The commonly used QWERTY keyboard which was originally designed for typewriters, was purposely laid-out to be inefficient to reduce jamming. As described in the background, the over usage of the QWERTY keyboard led to stress related injuries in the hands of the user.

Other keyboard layouts like DVORAK and COLEMAK are also in used in several parts of the world. But when the usage and the effects of these all types of keyboard layouts are compared with the “REHAAN BSQ” keyboard invention, the “REHAAN BSQ” keyboard seems to be more promising in terms of providing better balance for usage of right and left hand and individual fingers.

The study was performed using a computer program to analyse the usage of each hand, row and each finger while using the traditional QWERTY, DVORAK and COLEMAK keyboard layouts by using large amounts of data from various classical books, Wikipedia, poems and dissertations. The computer program simulated human-like-typing and analysed row-usage, finger-usage and hand-usage. According to the first study, the QWERTY layout was inefficient in the greatest number of categories.

The computer program parsed huge amount of text to see how often each alphabetic character is used. Based on how often a particular character, “a” or “f” for example, was used, the “REHAAN-BSQ” layout was designed. The same program that analysed the other keyboard layouts was used to analyse the “REHAAN-BSQ. The results of the study are tabulated below.

The table below represents the statistics relating to the right hand and left hand usage with the keyboard layouts.

| | Left Hand Finger Usage in Percentage | | | | |
|---|---|---|---|---|---|
| | | Ring | Middle | Index | |
| | Pinkie | Finger | Finger | Finger | Thumb |
| Qwerty Keyboard | 14.9% | 13.8% | 33.8% | 37.5% | NA |
| Dvorak Keyboard | 18.8% | 19.3% | 29.1% | 32.8% | NA |
| Colemak Keyboard | 17.8% | 17.0% | 25.7% | 39.5% | NA |
| REHAAN BSQ | 17.8% | 20.5% | 23.0% | 38.7% | NA |

The left hand usage of the different keyboard layouts revealed that the usage of the pinkie finger in the “REHAAN BSQ” is around 17.8%, ring finger in “REHAAN BSQ” is around 20.5%, middle finger in “REHAAN BSQ” is around 23.0%, and index finger in “REHAAN BSQ” is around 38.7%. The Thumb is used only for space bar and is ignored. “REHAAN BSQ” layout does a better job of increasing the load on the pinkie finger and the ring finger while decreasing the load on the middle finger as compared to the QWERTY keyboard layout.

| | Right Hand Finger Usage in Percentage | | | | |
|---|---|---|---|---|---|
| | | Ring | Middle | Index | |
| | Pinkie | Finger | Finger | Finger | Thumb |
| Qwerty Keyboard | 8.4% | 28.6% | 21.5% | 41.5% | NA |
| Dvorak Keyboard | 21.2% | 26.2% | 24.1% | 28.5% | NA |
| Colemak Keyboard | 16.1% | 19.1% | 29.4% | 35.4% | NA |
| REHAAN BSQ | 23.8% | 17.1 | 20.0% | 39.0% | NA |

The right hand usage of the different keyboard layouts revealed that the usage of the pinkie finger in the “REHAAN BSQ” is around 23.8%, ring finger in the “REHAAN BSQ” is around 17.1%, middle finger in the “REHAAN BSQ” is around 20.0%, and index finger in the “REHAAN BSQ” is around 39.0%.

In the Right hand fingers, the QWERTY keyboard puts maximum load of 41.5% on the Index finger while has the minimum load of only 8.4% on the pinkie finger. “REHAAN-BSQ” layout attempts to use all the fingers of the right hand almost equally and if you compare it with the QWERTY layout, the load on pinkie is increased to 23.8%. The load on the Ring finger decreases from 28.6% in QWERTY to 17.1% in “REHAAN-BSQ” layout while the load on middle finger and index finger remain almost the same in both QWERTY and “REHAAN-BSQ” layout.

The comparative study of hand usage was carried out which determine the percentage of usage of right and left hand with the different types of keyboard layouts. The comparison data is tabulated below.

Hand Usage In Percentage

| | Right Hand Usage | Left Hand Usage |
|---|---|---|
| QWERTY Keyboard | 43.4% | 56.6% |
| DVORAK Keyboard | 55.6% | 44.4% |
| COLEMAK Keyboard | 52.8% | 47.2% |
| REHAAN BSQ | 56.2% | 43.8% |

The comparison studies of the hand usage of the various layouts, reveals that the usage of the right hand with the “REHAAN BSQ” is around 56.2% which is higher than any other keyboard layout. Subsequently, the left hand usage in “REHAAN-BSQ” is 43.8% which is the lowest when compared to the other layouts. The invention increases the usage of the right hand which is the dominant hand for most humans.

Another study was carried out to determine the row usage in different types of keyboard layouts. The statistical data is tabulated below.

| | Row Usage in Percentage | | |
|---|---|---|---|
| | Upper Row | Home Row | Lower Row |
| | Usage | Usage | Usage |
| QWERTY Keyboard | 49.9% | 31.6% | 18.5% |
| DVORAK Keyboard | 25.0% | 67.5% | 7.5% |
| COLEMAK Keyboard | 17.0% | 71.2% | 11.8% |
| REHAAN BSQ | 22.0% | 73.1% | 4.9% |

The row usage studies done with the various types of keyboard layouts revealed that the upper row usage in the “REHAAN BSQ” is around 22.0%, home row usage is around 73.1% which is the most used and the lower row usage is around 4.9%.

The home row is the row is highly preferred for use by the users and the statistics reveal that the percentage is higher than any other type of the keyboard layout. This makes the “REHAAN BSQ” more convenient and promising in balancing the usage by both hands and by individual fingers.

### REFERENCES CITED

[1] “Carpal Tunnel Syndrome: A painful condition of the hand and fingers caused by compression of a major nerve where it passes over the carpal bones through a passage at the front of the wrist. It may be caused by continual repetitive movements or by fluid retention.” Source: Oxford Dictionary
[2] US Patent documents

| | | |
|---|---|---|
| U.S. Pat. No. 2,040,248 | May 1936 | August Dvorak and |
| | | William L Dealey. |
| U.S. Pat. No. 6,443,643 B1 | September 2002 | Hernan Camacho and |
| | | Robert Granadino |
| U.S. Pat. No. 5,676,476 A | October 1997 | Alan K Uke |

I claim:

1. A Keyboard layout, comprising:
a. a first group of keys located on the top row of the main keyboard surface for accepting the command from the user; wherein said first group of keys on the top row includes BGPMW.CUFY, V;
b. a second group of keys located on the middle row or home-row of the main keyboard surface for accepting the command from the user; wherein said second group of keys on the middle row includes SNITLHEAORD; and
c. a third group of keys located on the lower row of the main keyboard surface for accepting the command from the user, wherein said third group of keys on the lower row includes Q:;X{[?/}]K′″JZ|\.

2. A keyboard layout as claimed in claim 1, wherein the keys arrangement is such that maximum keys are place in the home-row or middle row which reduces the stress on wrist tendons.

3. A keyboard layout as claimed in claim 1, wherein the load on the middle finger is reduced while typing and the load is distributed to the pinkie finger and ring finger in the said keyboard layout.

4. A keyboard layout as claimed in claim 1, wherein there is a balance usage of both hands and all the fingers of the user while typing on the said keyboard layout.
